(19) United States
(12) Patent Application Publication
(10) Pub. No.: US 2016/0171511 A1
(43) Pub. Date: Jun. 16, 2016

(54) REAL-TIME DATA ANALYTICS FOR ENHANCING SALES AND OTHER SUPPORT FUNCTIONS

(71) Applicant: PROSPERO ANALYTICS, INC., Saratoga, CA (US)

(72) Inventors: Anurag Goel, Saratoga, CA (US); Punit Bhargava, Fremont, CA (US)

(21) Appl. No.: 14/909,693

(22) PCT Filed: Aug. 1, 2014
(86) PCT No.: PCT/US14/49494

§ 371 Date: Feb. 2, 2016

Related U.S. Application Data
(60) Provisional application No. 61/861,818, filed on Aug. 2, 2013.

(51) Int. Cl. G06Q 30/02; H04L 29/08; G06Q 50/00

(52) U.S. Cl. CPC G06Q 30/0201; G06Q 50/01; H04L 67/22; H04L 67/306

(57) ABSTRACT

Methods, systems, and devices are disclosed for monitoring user activities on a web page or application user interface and/or audio communication channels and providing analyzed user data in real time for a range of applications based on the user data. In one aspect, a computer implemented method to collect and analyze web and/or voice data includes aggregating information of an end user across a plurality of communication channels, e.g., including web channels, voice channels, and social media channels, and providing specific information about the end user to a commercial entity to enhance an interaction, service or experience to the end user provided by the commercial entity.

### CROSS REFERENCE TO RELATED APPLICATIONS

This patent document claims the benefit of priority of U.S. Provisional Patent Application No. 61/861,818 entitled “REAL-TIME WEB AND VOICE DATA ANALYTICS FOR MONITORING USER WEB ACTIVITIES TO SUPPORT SALES AND OTHER SUPPORT FUNCTIONS” filed on Aug. 2, 2013. The entire content of the above patent application is incorporated by reference as part of the disclosure of this patent document.

### TECHNICAL FIELD

This patent document relates to systems, devices, and processes that use web and voice data analytics technologies.

### BACKGROUND

Web analytics is the measurement, collection, analysis and reporting of internet data for purposes of understanding and optimizing web usage. In a basic form, web analytics tools can be used for measuring web traffic. In addition though, web analytics tools also can be used for business and market research, and to assess and improve the effectiveness of a web site. For example, web analytics tools can provide information about the number of visitors to a website and the number of page views and help to gauge traffic and popularity trends useful for market research.

Generally, there are two categories of web analytics: off-site and on-site web analytics. Off-site web analytics refers to measurement, collection, analysis and reporting of data activity on the Internet as a whole, for example, such as websites' potential audience (e.g., “opportunity”), share of voice (“visibility”), and buzz (“comments”). On-site web analytics refers to measurement, collection, analysis and reporting of data activity on web visitors' behavior once on particular websites, e.g., characterizing the performance of a website in a commercial context. Examples of on-site web analytics includes drivers and conversions, e.g., the degree to which different landing pages are associated with online purchases.

Voice analytics is the analysis of speech to extract useful information about the speech content. Voice analytics techniques can include automatic speech recognition processes that determine words and phrases from auditory speech and speech analyses processes that determine the topics discussed, the emotional character and categorization of the speech, and speech versus non-speech (e.g., pauses or silences) of the determined words and phrases. Voice analytics typically include post-processing techniques on the recorded speech. For example, voice analytics techniques can include audio mining to identify spoken keywords or phrases and report the mined data. Voice analytics techniques have been employed in contact centers of businesses to extract intelligence on their customers including information related to strategy, product, process, operational issues and contact center agent performance. Such information can be used by decision-makers of the business to quickly react to customers' concerns, as well as evaluate the performance of the contact center agents and identify specific areas in which an agent may need additional training to improve the agent's customer service.

### SUMMARY

Techniques, systems, and devices are disclosed for monitoring user activities on a web page or application user interface and/or audio communication channels and providing analyzed user data in real time for a range of applications based on the user data.

In one aspect, a computer implemented method to collect and analyze web and/or voice data includes aggregating information of an end user across a plurality of communication channels, e.g., including web channels, voice channels, and social media channels, and providing specific information about the end user to a commercial entity to enhance an interaction, service or experience to the end user provided by the commercial entity.

The subject matter described in this patent document can be implemented in specific ways that provide one or more of the following features. The disclosed methods and systems can track user activity and analyze user activity to provide guidance to a commercial entity to make sales and/or improve retention. For example, the disclosed methods and systems can be used to track web activity of an end user on communication channels of a business entity for supporting real-time sales and support. Additionally, for example, the disclosed methods and systems can be used to track voice conversations between a caller and customer service/contact center agent in real time, transcribe and analyze the conversations into data in real time, and use the data for real-time sales and support.

### BRIEF DESCRIPTION OF THE DRAWINGS

FIG. 1A shows an example of a communication network for providing real-time data analytics to a commercial entity.

FIG. 1B shows a block diagram of an exemplary computer in the exemplary communication network of FIG. 1A.

FIG. 1C shows a block diagram of a system architecture of an exemplary analytics engine capable of collecting user data and providing real-time analytics to a commercial entity.

FIG. 2A shows a diagram of an exemplary analytics engine of the disclosed technology.

FIG. 2B shows an exemplary architectural diagram of the disclosed data analytics technology.

FIG. 3 shows an exemplary data flow diagram of the disclosed technology.

FIG. 4 shows an exemplary software architecture diagram of the disclosed technology.

FIG. 5 shows a block diagram of exemplary software modules of the analytics engine.

FIG. 6 shows an illustrative diagram of the system architecture of an exemplary analytics engine deployed across commercial entity and individual user systems and devices.

FIG. 7 shows a diagram of an exemplary analytics engine depicting the interaction between the different modules.

FIG. 8 shows two exemplary processes for data management of the exemplary analytics engine.

### DETAILED DESCRIPTION

Techniques, systems, and devices are disclosed for monitoring user activities on a web page or application user interface and/or audio communication channels and providing analyzed user data in real time for a range of applications based on the user data.

In one aspect, the disclosed techniques include a computer implemented method for providing web and voice analytics to a commercial entity. The computer implemented method includes collecting data of an end user's interactions with the commercial entity via communication channels, e.g., such as a website-based communication, a voice-based communication, and/or a social media based communication. For example, the collected data can include content of interest to the end user collected from keywords, search criteria, user physical location, customer relationship management (CRM) data, billing data, web data including user-viewed websites, social media data including information posts, user posted and viewed tweets and/or blogs, and/or user posted likes and dislikes, or information uploads and downloads of content of interest to the end user, etc., e.g., which are inputted or spoken by the end user via the communication channel(s). The computer implemented method includes analyzing the collected data, e.g., by data mining, keyword searching or recognizing, data categorizing, or data relevancy identifying to extract end user specific content. For example, the end user specific content can be used to form a user profile of the end user drat includes user preferences, user locations, user browsing and/or search habits, and user ordering or purchasing history. The computer implemented method includes creating a data index of the analyzed data in one or more data insight models. For example, the created data index can include a profile of the end user that is formed based on the extracted end user specific content. In some implementations, for example, the computer implemented method includes reporting in real time the results from the data insight models to provide information based on the end user specific content, e.g., which can be presented to an agent of the commercial entity during interaction with the end user (e.g., a voice call or online chat), or can be presented to the end user in real time during his/her web-based experience on the website of the commercial entity. For example, the information reported to the agent in real time during the interaction can include an actionable list of items to ask or suggest to the end user. In some implementations, for example, the computer implemented method also includes collecting outside user data about the end user from another entity, and analyzing the outside user data to extract the end user specific content.

The computer implemented method can be implemented using an analytics engine that is configured on a computer system setup for a commercial entity. For example, the analytics engine can include software modules implemented by the computer system, e.g., including a collection module established on a website (e.g., e-commerce website) of the commercial entity, and a data processing module that interacts with a database stored on one or more computers of the computer system and/or of other computer systems. The software modules of the analytics engines can operate on one or more computers of the computer network to communicatively interact in a communications network (e.g., ‘the cloud’).

In addition to the user interactions on a website-based communication channels, an end user can interact with the commercial entity through the voice and/or social media channels, in which information provided by the end user on the voice channel and/or social media channel can be collected and uploaded to the cloud. The computer implemented method can include a data processing pipeline process that processes the commercial entity's proprietary data acquired from the end user interactions to drive valuable insights about the end user. These insights are delivered to the commercial entity in real time through a variety of techniques and formats, e.g., including, but not limited to, agent screen splash interfaces, executive reporting dashboard, and updated website.

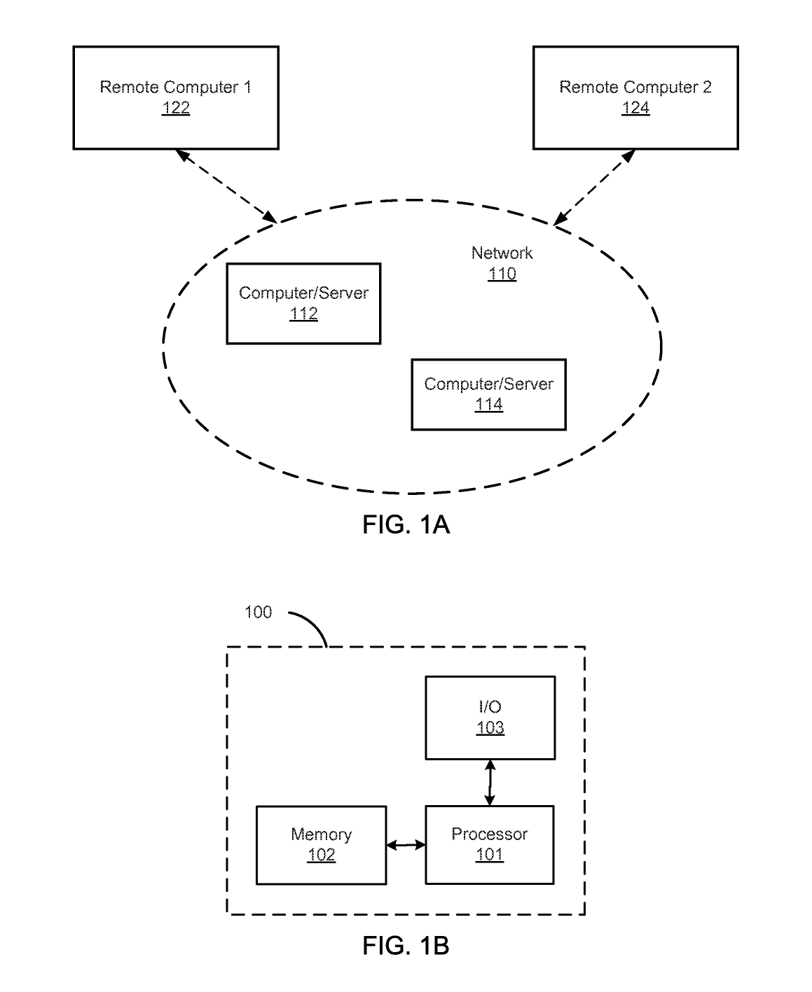

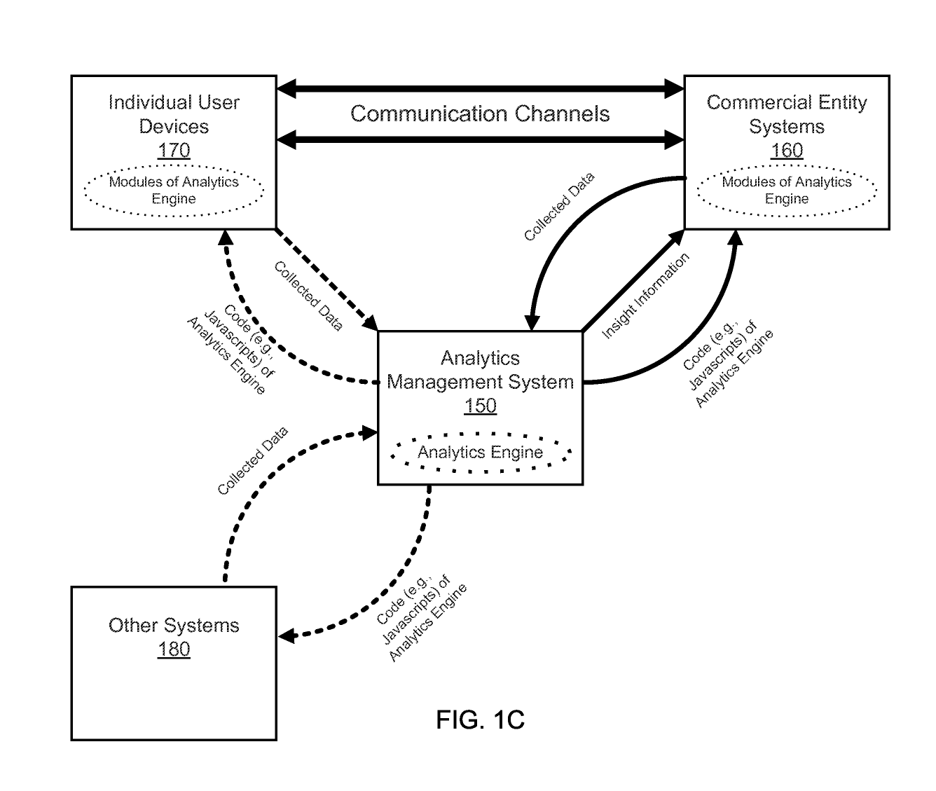

FIG. 1A shows an example of a communication network 110 for providing real-time data analytics to a commercial entity. The communication network includes computers or servers 112, 114 and communicates with remote computers, servers or computing devices 122, 124. The computers or servers 112, 114 in the network 110 can be operated by the commercial entity and configured to include the analytics engine capable of providing real-time analytics about individual and groups of individual users of services and/or products provided by the commercial entity. For example, the remote computers or computing devices 122, 124 can include desktop and laptop computers, tablets, smartphone devices, and wearable communication devices. The analytics engine can be configured on one or more computers or servers 112, 114 operated by the commercial entity to provide e-commerce, communication and other types of services to individual users (e.g., subscribers, customers, clients, etc.). For example, software modules of the analytics engine can reside on the computers or servers 112, 114 operated by the commercial entity, and also on the remote computers or computing devices 122, 124 utilized by the commercial entity. Additionally, in some implementations, software modules of the analytics engine can reside on the remote computers, servers, or computing devices 122, 124 of the individual end users.

The computers or servers 112, 114 and/or the remote computers, servers, or computing devices 122, 124 can be configured as a computer 100 having a central processing unit, memory unit, and input/output unit, as shown in FIG. 1B. The computer 100 includes a central processing unit 111 to process data and a memory unit 112 in communication with the central processing unit 111 to store data. The computer 100 includes an input/output (I/O) unit 113 in communication with the central processing unit 111 that provides wired and/or wireless interfaces compatible with typical data communication standards for communication of the computer with other computers and computer systems, or external interfaces, sources of data storage, or display devices, among others. For example, the memory unit 112 can include processor-executable code, which when executed by the central processing unit 111, configures the computer 100 to perform various operations, such as receiving information, commands, and/or data, processing information and data, and transmitting or providing information/data to another entity or to a user. For example, the I/O unit 113 can provide wired or wireless communications using one or more of the following communications standards, e.g., including, but not limited to, Universal Serial Bus (USB), IEEE 1394 (FireWire), Bluetooth, IEEE 802.111, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G/4G/LTE cellular communication methods, and parallel interfaces, among others. In some implementations, the computer 100 can be included in the network 110 as a computer or server 112, 114 and/or as a remote computer 122, 124 and in communication with other computers via the Internet.

FIG. 1C shows a block diagram of a system architecture of an exemplary analytics engine of the disclosed technology capable of collecting user data and providing real-time analytics to a commercial entity. The analytics engine includes multiple software modules operating on one or more computers in one or more computer systems, in which the analytics engine is centralized in an analytics management system 150. The software modules of the analytics engine can operate on one or more computers of the individual users, of the commercial entity, and of others (e.g., such as social media networks). As shown in FIG. 1C, some software modules of the analytics engine operate on computers in computer systems of the commercial entity, shown as commercial entity systems 160. The analytics engine is configured to collect data (e.g., about the individual users) from the commercial entity systems 160, and in real-time, process the collected data at the analytics management system 150 to provide insight information about the individual users to the commercial entity systems 160. For example, various modules can be integrated with the commercial entity systems 160 by applying code (e.g., Javascripts) on computers of the commercial entity systems 160. For example, the collected data can include keywords and/or search criteria provided by the user to the commercial entity over a communication channel, and/or CRM data and/or billing data stored by the commercial entity.

In some implementations, for example, some software modules of the analytics engine may operate on computing devices of the individual users, shown as individual user devices 170 in FIG. 1C. The analytics engine can be configured to collect data about an individual user directly from the individual user via the individual user devices 170, and in real-time, process the collected data at the analytics management system 150 to generate the insight information about the individual user to provide to the commercial entity systems 160. In one example, various modules can be integrated with the individual user devices 170 by applying code (e.g., Javascripts) on the computing devices of the individual users. In another example, in addition or alternatively, the analytics engine can communicate with individual user devices 170 to request data (e.g., such as geographic location of a mobile device) to be processed in real time to generate the insight information.

In some implementations, for example, some software modules of the analytics engine may operate on computers of other entities in the network 110, shown as other systems 180 in FIG. 1C. The analytics engine can be configured to collect data (e.g., about the individual users) from the other systems 180, and in real-time, process the collected data at the analytics management system 150 to generate the insight information about the individual users that is provided to the commercial entity systems 160. For example, other systems 180 can include social media networks, personal websites, news articles, etc. where information on individual users is available over the Internet. In some instances, for example, various modules of the analytics engine can be integrated with the computers of other systems 180 by applying code (e.g., Javascripts) on such computers.

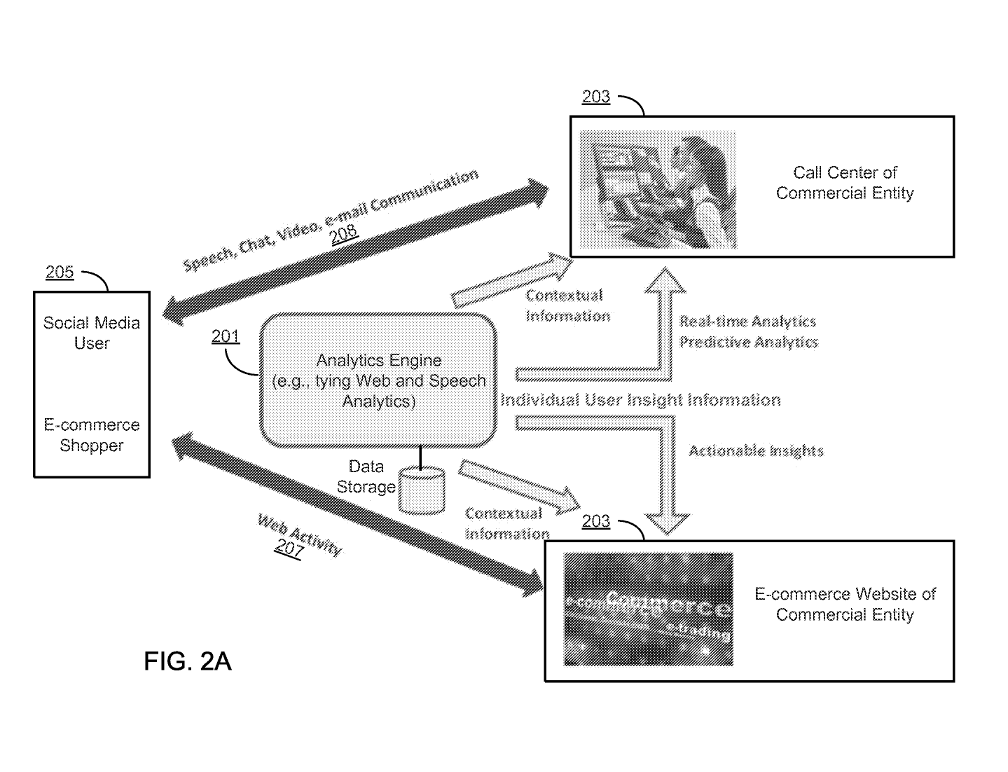

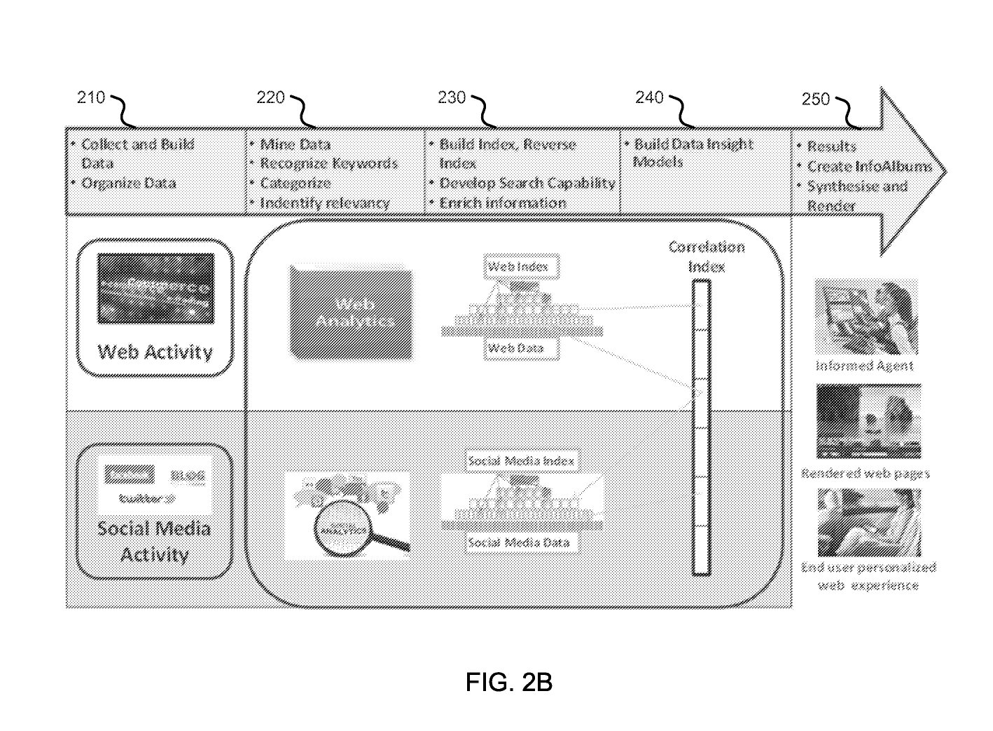

FIG. 2A shows a diagram of the exemplary analytics engine of the disclosed technology configured to interact with website-based, voice-based, and/or media-based communications channels between an individual end user (e.g., social media user or e-commerce shopper) and a commercial entity that sells goods and/or services using at least one of the communications channels. Analytics engine 201 is shown in FIG. 1A to capture and collect data from individual end user 205 on any of the communication channels 207, 208 (e.g., web communication channel 207, and speech, chat, video, and/or email communication channel 208) and process the collected data to form a user profile and/or produce individual user insight information that is provided to the commercial entity 203 in real time. For example, the user profile formed by the exemplary analytics engine can be based on user preferences acquired and/or derived from user-inputted keywords and/or search criteria, the physical location of the individual end user, customer relationship management (CRM) data, billing data, web data and/or social media data including user-actively viewed websites by the end-user and past viewed web activity, user-posted information including comments, online voting results, wall and/or website posts, tweets and/or messages posts, content likes and dislikes, downloads and uploads (e.g. of media files, software applications, etc.), and other information providing content of interest to the individual end user. In some examples, the individual user insight information can include contextual information about the individual end user's interests as communicated by the individual end user using the communication channels 207, 208, e.g., such as the products/services searched and researched by the individual end user on the communication channel 207, 208. The contextual information produced by the exemplary analytics engine can also include additional information related to individual end user's interest that was not searched or inquired by the end user. In some examples, the individual user insight information can include predictive analytical information related to the individual end user's interests, e.g., such as suggested products/services that could be provided to the individual end user in real time (e.g., during the searches and browsing being performed by the user). Additionally, the predictive analytical information can include a list of individual user interest-relevant questions and/or suggestions provided to the commercial entity 203, which can be presented indirectly to the user. e.g., via a customer service and/or support representative, and/or presented directly to the user, e.g., via a screen splash window such as an online chat window or other virtual agent. In some examples, the individual user insight information can include actionable insights or lists about the individual end user's interests and/or needs based on the collected data of the individual end user's activities on the communication channels 207, 208. For example, the actionable insights or lists can be integrated into the communication channels 207, 208, provided by the commercial entity 203 (e.g., such as the website or customer service phone center), to enhance and/or personalize the individual end user's experience in another interaction (e.g., follow-up or future interaction) with the commercial entity 203.

The disclosed web and voice analytics technology includes an architecture based on three aspects: captured data (e.g., both structured and unstructured), real-time analytics, and batch processing. For example, the processing engine can utilize both structured and unstructured data (for example, captured or collected by the collection engine of the disclosed technology) to build data insight models and organize them for fast processing. The captured data can be analyzed in real time to derive valuable insights and delivered to the customer in real time, e.g., via the exemplary agent notification, executive summary or reporting dashboard, and/or updated website. For example, the captured data can also be batch processed in real time with ‘big data’ algorithms on a frequent basis to further enhance the data models and identify ways to improve correlation and insights.

In some examples of the computer implemented method, a phased approach of collecting and organizing data, analyzing the data, building data indexes and models, and reporting results is used. FIG. 2B shows an example of the disclosed analytics architecture. For example, the computer implemented method can include a process 210 to collect and organize data from web activity, social media activity, and/or voice channel activity. The computer implemented method can include a process 220 to analyze the collected and organized web activity, social media activity, and/or voice channel activity data by implementing techniques including data mining, keyword searching/recognizing, categorizing, and identifying relevancy of the data. For example, data mining techniques can include computational processing to discover patterns in the collected data (e.g., using artificial intelligence, machine learning, statistics, and database management systems methods) to extract information from the collected data and transform it into an understandable format and organization. The computer implemented method can include a process 230 to build a web data index, social media data index, and/or voice data index that can be integrated into a correlation index, e.g., operable as a forward index and reverse index to develop search capability and enrichment of information among the aggregated information. The computer implemented method can further include a process 240 to build data insight models, and a process 250 to report results from the data insight models and create information albums for purposes including informing live and virtual service agents, rendering web pages, and providing enhanced end user personalized web experiences.

In some implementations, a data insight model built by the process 240 can include a unique profile of information organized in a predetermined structure that is accessible to the analytics engine to selectively acquire particular information about each end user and formulate such information (e.g., as insight information) in a report to the commercial entity. The data insight model can be structured to allow variations of the report, e.g., including using the same collected and analyzed end user specific content information or different end user specific content information in the report, based on the context of the circumstance to which the report is delivered to the commercial entity in real time. For example, as data is processed, useful bits of information are extracted at each step. As every end user is different and not all pieces of information are available from every end user, this results in infinite permutations of information. In order to be able to use that dataset in a meaningful way, it needs to be mapped to a finite set of models and/or profiles that comprise the data insight model, e.g., which can be based on previous experiences. What bits of information, in what order, and how much weight may be attached to each piece of information, for example, can be used to arrive at the pre-defined models/profiles of the data insight model. These pre-defined models/profiles are developed based on evaluation of the data.

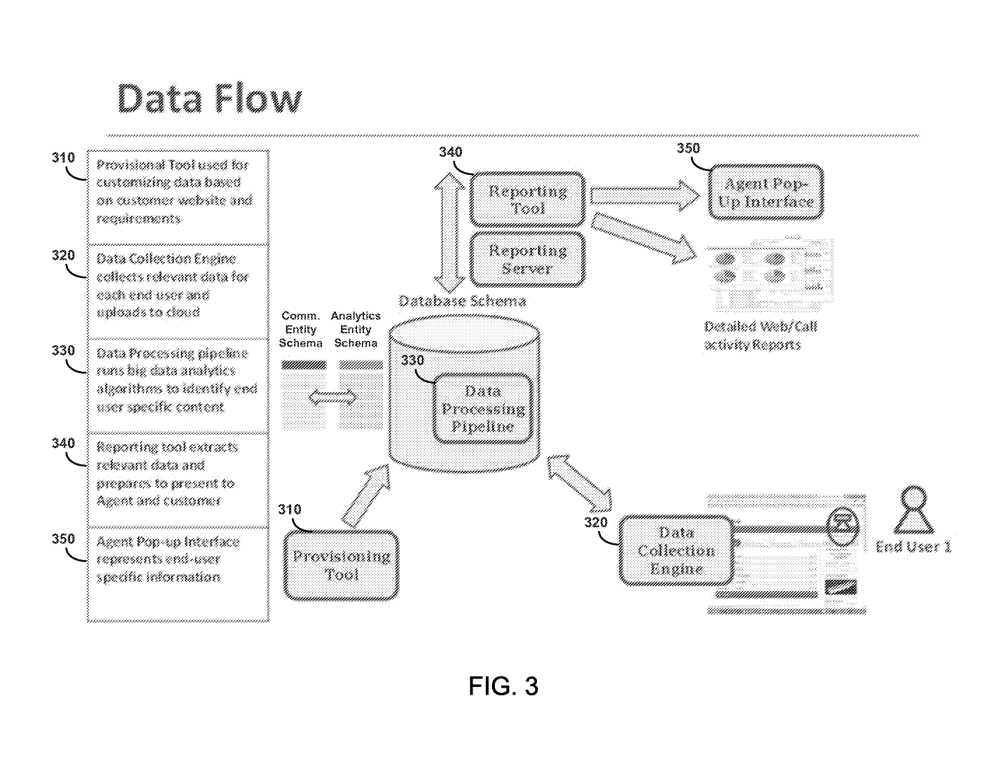

FIG. 3 shows a diagram depicting an exemplary data flow process using the analytics engine 201 of the disclosed technology. In the example shown, the exemplary analytics engine includes a data provisioning module 310 used for customizing data based on a website and requirements. The exemplary analytics engine can include a data collection module 320 to collect relevant data for each end user and upload the collected relevant data to a data storage, e.g., in the cloud. The exemplary analytics engine can include a data processing pipeline module 330 to process the proprietary data acquired from an end user of a data channel of a commercial entity (e.g., such as a website, voice, or social media channel) to identify end user specific content, e.g., which can provide insights about the end user. For example, the identified end user specific content can include analyzed information based on the user's demographical data, behavioral data, location data, user-specified preference data, etc. in relation to a contextual situation of the user with the commercial entity (e.g., such as a reason for the user to communicate with the commercial entity via the communications channels). For example, the identified end user specific content can include the analyzed information that is analyzed by the analytics engine from the collected data, e.g., included in the data insight model. The exemplary analytics engine can include a reporting module 340 to extract the relevant data and prepare it for presentation by an agent and/or a customer of the commercial entity. The exemplary analytics engine can include an interface module 350 to provide a user interface, e.g., such as an agent screen splash interface, to represent the end user-specific information.

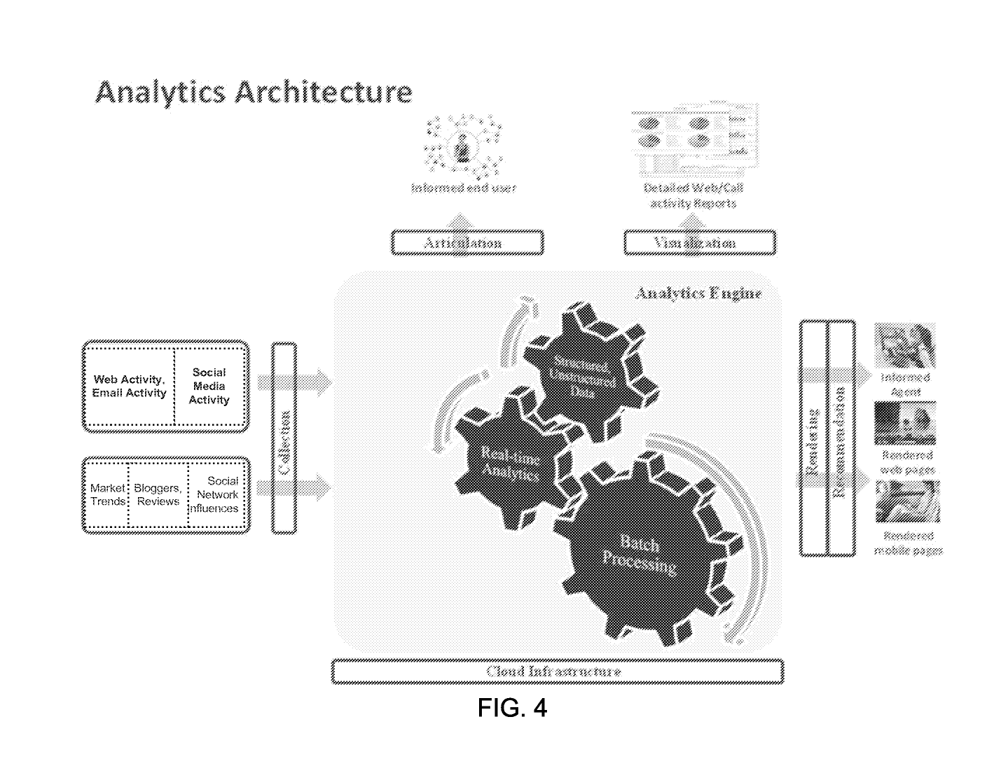

FIG. 4 shows an illustrative diagram depicting an example of the software architecture of an exemplary system of the disclosed technology. In the example shown, the exemplary software architecture includes an analytics engine to manage data collection on multiple communication channels and process structured and unstructured data in real time. For example, such data can be collected, also in real time, from a variety of communication channels, e.g., including web activity, email activity, social media activity, and/or voice activity of a target user (e.g., such as a target customer of a business entity) and information related to the end user's activity including market trends, existing blogs and/or reviews, social network influences, etc. The exemplary analytics engine can provide articulation, visualization, and reports and recommendations to an end user. The analytics engine can be managed by an analytics management system that interfaces with various computer systems of the commercial entity, e.g., such as the computers hosting websites of the commercial entity accessible to end users via communication channel 207 and computers used by representatives of the commercial entity communicating with end users via communication channel 208, shown previously in FIG. 2A.

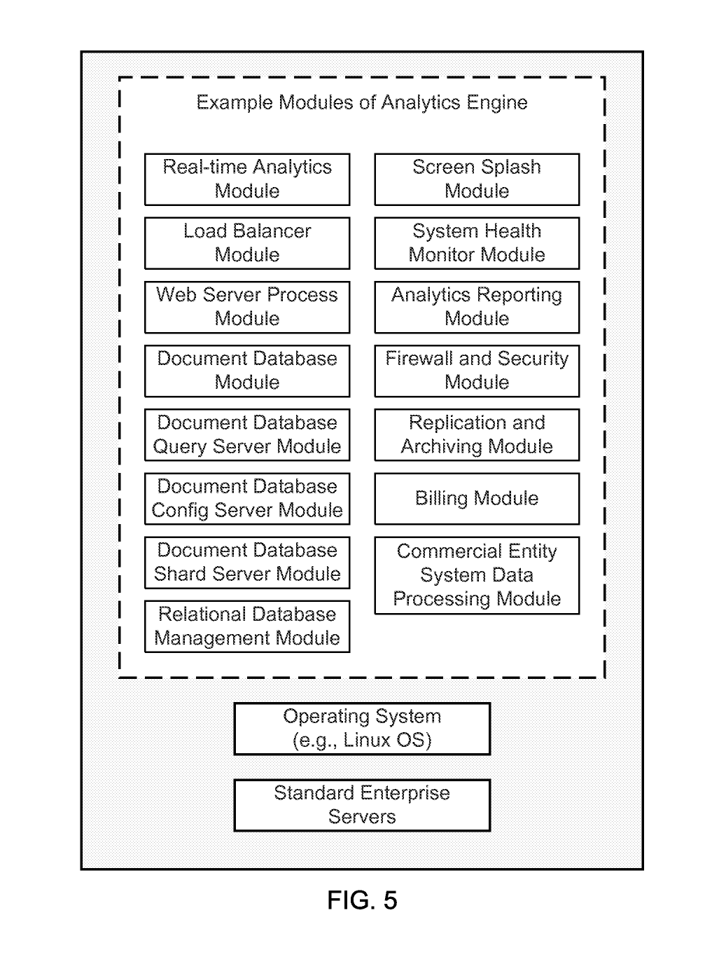

FIG. 5 shows a block diagram of exemplary software modules of the analytics engine. The analytics engine can be configured to have a scalable, high performing, and modular architecture that supports on premise, cloud, and hybrid operation. The analytics engine includes a real-time analytics module on the analytics management system 150. The real-time analytics module is implemented (e.g., launched) on demand. In implementations, the real-time analytics module analyzes small subsets of most recent data collected by other aspects of the analytics engine. For example, the data analysis (e.g., small subsets) can be implemented over a configurable duration (e.g., such as 1 hour) to limit the scope of the search that the analytics engine has to conduct in order to make decisions about a particular transaction. In some implementations, the real-time analytics module can be launched on the computer systems 160, individual user devices 170, and/or other systems 180 based on such system requirements and permissions. In some implementations, for example, depending on the size of data to be analyzed, multiple real-time analytics modules can be launched.

In some implementations, for example, the analytics engine can include a load balancer module used to load balance incoming requests initiated by software code of the disclosed analytics engine (e.g., Javascript code) running on a website of the commercial entity. The exemplary load balancer module can ensure that the incoming requests are uniformly distributed across multiple web servers (e.g., servers 112, 114). In such instances when more web servers are required, for example, they can be added without any interruption to existing operations.

In some implementations, for example, the analytics engine can include a web server process module used to aggregate information from one or more web servers of a commercial entity and process the information on one or more servers of the analytics management system. In an illustrative example, the exemplary Javascript code running on a website of a commercial entity can collect relevant data from the commercial entity's webpage and send it as an HTTP POST request to servers of the analytics management system. For example, these servers are running as part of the standard Apache web server process. The post handling code extracts all the required information and inserts it into/saves it locally.

In some implementations, for example, the analytics engine can include a document database module to manage data flow between databases on multiple servers. For example, the document database module can include MongoDB. The exemplary MongoDB document database module functionality can be broken into three main components and placed on different servers for redundancy and scalability, e.g., Query Server; Config Server; and Shard Server.

The analytics engine can include a document database query server module (e.g., MongoDB Query Server). The MongoDB Query Server module is a process module that runs on the same system as the web server process module and is responsible for figuring out which MongoDB server the data should be sent to for accessing or storing. The MongoDB Query Server module is light weight because of its minimal requirements.

The analytics engine can include a document database config server module (e.g., MongoDB Configuration Server), which is the second part of the MongoDB topology. The configuration information (e.g., which servers make up the shard, in which collections are sharded, etc.) is stored on the configuration servers operating the document database config server module. The exemplary MongoDB Query Server(s), described above, communicate with configuration servers to figure out where the data should be sent.

The analytics engine can include a document database shard server module (e.g., MongoDB Shard Server), which is the third part and the main piece of the MongoDB topology. The actual data is stored by the shard servers operating the document database shard server module. The number of servers operating here is scalable, e.g., and can be increased as the data grows. For example, if the volume of data increases to 1 TB, instead of hosting it on a single server, three extra servers can be added to the shard configuration and the data on each of them will then be limited to 250 GB on each.

In some implementations, for example, the analytics engine can include a relational database management module. For example, the relational database management module can include MySQL Server, which is the current industry standard used for all other storage needs, e.g., including aggregate data, front end and user interface information, application configuration etc. In the exemplary architecture of the analytics engine, the amount of data stored using the relational database management module (e.g., MySQL Server) can be relatively small compared to the user POST data stored using the document database module (e.g., MongoDB) including its sub-modules.

In some implementations, for example, the analytics engine can include a screen splash module to provide the capability to deliver a ‘screen splash’ on a computer terminal used by an agent of the commercial entity (e.g., a screen splash on the agents screen) with the desired relevant end-user insight information, e.g., in real-time during a communication session ongoing between the agent and the individual end user. For example, based on the individual end-user's activities, relevant information is stored and compacted in databases on or accessible to the analytics management system 150. Illustratively, at the time of the individual end user connecting with an agent, the screen splash module queries the database, interacts with the real-time analytics module, and collates the information to be delivered as a screen splash or other information element on the agent's computer terminal (and/or, in some examples, on the screen of the individual end user's computing device screen).

In some implementations, for example, the analytics engine can include a system health monitor module to monitor performance and functional aspects of the analytics engine, e.g., on the analytics management system 150, and in some exemplary implementations on the computers of systems/devices 160, 170 and/or 180.

In some implementations, for example, the analytics engine can include an analytics reporting module to provide reporting services of the analytics engine, e.g., such as individual user insight information in real-time to the commercial entity. In some implementations, for example, online dashboards on the computers of the commercial entity systems 160 (and in some exemplary implementations, on the devices 170 and/or other systems 180) are managed by the analytics reporting module. The analytics reporting module interfaces with the database(s) to search, access, process, and deliver the analytics reports.

In some implementations, for example, the analytics engine can include a firewall and security module to manage security settings from the dashboard. For example, only the ports needed for external communication are opened (ex: 80) on the servers. Also, for example, SSH access to the servers is limited from select IP addresses and only via using public-private key pairs.

In some implementations, for example, the analytics engine can include a replication and archiving module to provide automatic replication of data on multiple computers and/or computer systems. For example, MongoDB provides automatic replication. Yet, the replication and archiving module doubles the number of MongoDB shard servers required. In such configuration, every insert into the MongoDB is also copied (automatically) into other servers that are part of the replication pair. Another alternative to that is to archive the user POST so that in the event of any failure in MongoDB, the database can be rebuilt with the archived files, e.g., which can be accomplished by having the web server save the user POST data locally and then another application pick up that data and insert into MongoDB as well as copy it to a remote server where it is archived.

In some implementations, for example, the analytics engine can include a billing module or application that keeps track of the information elements which are provided to the commercial entity (e.g., on the agents' screens or uploaded to the computers of the commercial entity systems 160). The billing module or application can be used to generate a bill for the commercial entity (e.g., customer to the analytics management system 150) to pay. For example, the commercial entity can have an opportunity to ratchet the amount up and down as desired.

In some implementations, for example, the analytics engine can include a commercial entity system data processing module that interacts with various systems of the commercial entity to collate both in an online and offline mode data relevant to commercial entities. This module can store compacted anonymized encrypted user information. Data can be indexed appropriately for faster search and access and is utilized by the real-time analytics module to piece together the relevant information at the time of modelling the information.

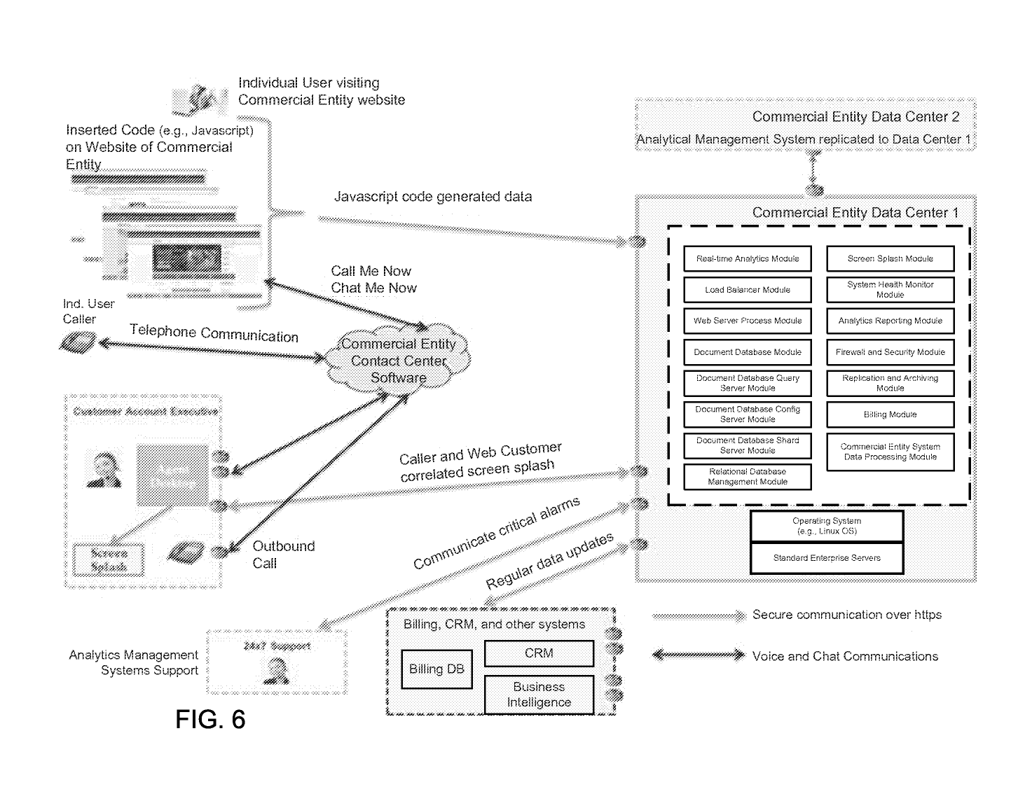

FIG. 6 shows an illustrative diagram of the system architecture of the exemplary analytics engine deployed across commercial entity and individual user systems and devices depicting the data flow. As shown in the illustrative diagram of FIG. 6, the disclosed analytics engine is deployed as an exemplary SaaS (Software as a Service) solution hosted in the cloud for implementation by a commercial entity. The analytics engine can be implemented for real time data collection at the website of the commercial entity, e.g., visited by individual users (e.g., customers, clients, subscribers, etc. of the commercial entity), and/or contact centers during communications between an agent of the commercial entity and the individual user (e.g., via telephone, online chat, etc.). The analytics engine can be implemented for real time analytics processing, storage, and generation of relevant insight information about the individual users. In some implementations, the analytics engine can incorporate non-real time data from other information sources of the commercial entity (e.g., such as CRM, billing data, etc.) and/or other entities (e.g., social media data, etc.) that is used to generate the insight information for use by the commercial entity to enhance sales, support, and/or retention. For example, the analytics engine can guide the commercial entity contact center to generate outbound calls to their individual user customers and/or handle received calls from their individual user customers to produce sales, support, and/or retention services based on the generated insight information. For example, the analytics data can be pushed in real-time for agent presentation via the commercial entity contact center. The exemplary system architecture also includes 24×7 support for the commercial entities utilizing the SaaS solution of the analytics engine upon deployment.

An illustrative example of implementation of the disclosed methods is described in which the commercial entity can include a cable provider. A potential customer or an existing customer (e.g., subscriber) of the cable company is exploring the website of the cable provider or an affiliated website. The Javascript code of the exemplary analytics engine generates the data which is sent over to the analytics management system running for the cable provider operating in the cloud. For example, the analytics engine is performing analytics of web behavior for this customer in the cloud and utilizes data associated with any past behavior data already collected and analyzed by the analytics engine. In this illustrative example, when the existing or potential customer decides to select on the call me button (or chat with me option) to create an interactive session with an agent of the cable provider. In this instance, the cable company web site generates an outbound call request to an agent to call the customer and sends the agent a contextual URL made available to provide insight information to the agent. The cable company contact center activates that outbound call request, calls the agent and when agent is available, calls customer and bridges them. In parallel it also pushes the contextual URL to the agent's screen. The agent's desktop screen executes the contextual URL and extracts information from the computers or servers of the analytics management system to be provided (e.g., using a splash screen) to the agent's screen. The analytics engine can be seamlessly integrated with a contact center of the commercial entity to provide better, relevant information to the contact center team in real-time for their interactions with customers (e.g., voice, chat and video). The exemplary analytics engine can utilize existing CTI (Computer Telephony Integration) integration points in the contact center solutions (of the exemplary cable company contact center) to be able to PUSH, in real time, screen splash information to the cable company agent produced by the real time analytics solution of the analytics engine.

In another illustrative example, an existing cable user who has been with the cable company as a customer (e.g., subscriber) for the last 11 months is nearing the expiry of his/her contract. He/she is a heavy user of both streaming TV media and Internet. Over a few visits to the cable company's website, the cable user reviews various offerings, e.g., such as premier cable channels, high speed Internet packages, and streaming video services, etc. The cable user searches the “renew contract” option and a search result brings an appropriate link. In this instance, the Javascript code of the analytics engine running on the computer systems of the cable company sends compact information (e.g., consumer activity/event information) to the a software application running on the commercial entity-dedicated cloud servers of the analytics management system. The cable user decides to reach out to an agent. The analytics engine can detect that the cable user is about to be connected to an agent and generates insight information in real-time to be provided to the agent. When the cable user and agent are connected, the insight information is provided to the agent, e.g., through a screen splash, using contact center software. The disclosed systems and techniques can provide in specific and actionable item(s) in real-time to the commercial entity to increase retention of existing customers thinking of leaving a service of the commercial entity, as well as enhance the ability to make new sales to potential customers for a service of the commercial entity.

The analytics engine can detect and analyze data from end user web, voice, and/or social media activity including mobile-based communications activity, e.g., in which in some examples, the communication medium includes chat, email, voice, video, etc. For example, the interaction can include the use of transcription in real time of a communication session between the end user and the commercial entity or other entities occupying the communication medium. For example, the disclosed techniques can also be implemented to predict consumer behavior of the end user and apply the predicted consumer behavior information for reducing of discovery time of end user interaction, converting the lead into a sale, improving of the user experience, providing the technical support, and/or upselling of related products to the end user.

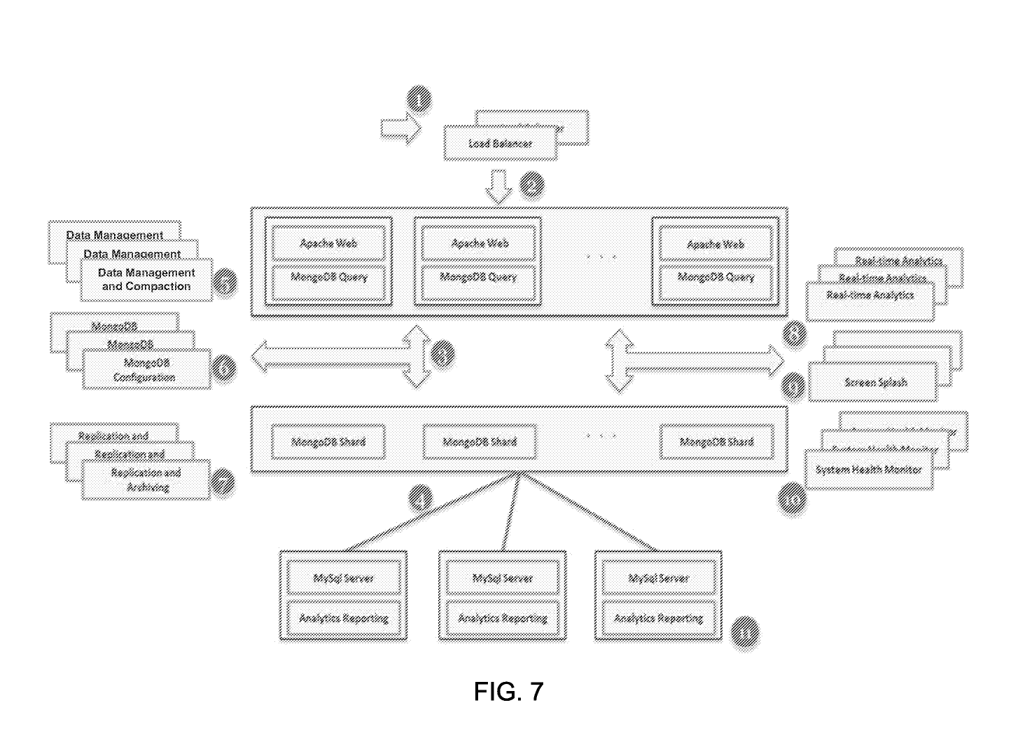

FIG. 7 shows a diagram of an exemplary implementation the analytics engine depicting the interaction between the different modules. As shown in the diagram, incoming requests depicted as step #1, also known as user POST, are generated by code (e.g., Javascript) of the analytics engine that executes on each webpage of the website of the commercial entity. This HTTP POST request contains information about that user interaction with that webpage and varies from page to page. Requests have at least some metadata that is sent to the load balancer module of the analytics engine. In some examples, every request may have some metadata that is always sent to the load balancer module, e.g., including data like timestamp, session id, source IP address etc. For example, the Javascript code can be inserted in every webpage of the website of the commercial entity. This can be achieved using standard tag management software, e.g., such as Tagman or Ensighten, or by inserting the Javascript code in a common page header or footer that is included in every page of the website. This enables the analytics engine to collect relevant end-user activity and events for real-time big data analytics. In one example, the Javascript code inserted into the commercial entity's website can include:

<script type=“text/Javascript”
src=“http://Cable Company.prosperoanalytics.com:8080/prosperojs/jquery-1.8.2-min.js”>
</script>
<script type=“text/Javascript”
src=“http://Cable Company.prosperoanalytics.com:8080/prosperojs/common.js”>
<script>

In the exemplary step #2 of FIG. 7, the load balancer module is the destination of the incoming POST request. It maintains a list of healthy web servers, based on configuration and continuous health checks, which are eligible candidates to handle the request. Based on a preset criteria, e.g., usually uniform load distribution, the request is forwarded to one of the web servers. Additional web servers can be added and removed as capacity needs change without any disruption to existing services.

In the exemplary steps #3, #4 and #6 of FIG. 7 for data storage, data is extracted from the POST request and temporarily saved in files on the local web server itself. The real-time analytics module continuously monitors the presence of these files, and as soon as it detects one, it extracts the data from it and inserts it into MongoDB using the document database modules (e.g., document database query server module, such as MongoDB query server, and document database config server module, such as MongoDB configuration server) to determine the most appropriate shard server to insert the data into, e.g. via the document database shard server module, such as MongoDB shard server.

In the exemplary step #7 of FIG. 7 for archiving data, the user POST request data are saved in temporary files locally as mentioned previously, e.g., one file per request. These files can be organized in directories by date/time in such a way so as to limit the number of entries at any level and hence improving file operation efficiency. In an illustrative example, the following directory name: “2014/04-Apr/20-Sunday/21/53/10” could be used to contain all incoming user POST requests that came in April 20th, when the time was 21:53:10. Also, for example, only directories that have data are created, so if there was no incoming POST request, nothing is created. This results in the most optimum performance when manipulating files, inserting their contents into the document databases (e.g., MongoDB), archiving the files, etc. Additionally, multiple processes can be spawned to increase the file processing rate should the incoming user POST increase. The background process also copies these files to an external server for archival purposes, maintaining the directory hierarchy. This allows the ability to rebuild the document database (e.g., MongoDB), should a need ever arise. Having a separate process enables decoupling of the web and database services so that either of them can be managed/expanded independent of the performance of the other.

In the exemplary steps #8, #9, and #11 of FIG. 7 for real-time analytics, exemplary modules of the analytics engine including the real-time analytics module, the screen splash module, the relational database management module (e.g., mySQL server), and the analytics reporting module can execute processes on the database data (e.g., MongoDB data) and to generate the insight information and produce analytic reports that can be presented to the commercial entity. The splash screen is the one example that generates output and displays it on an agent's console.

The exemplary step #5 of FIG. 7 represents one of the key aspects of the analytics engine that includes a data management and/or compaction module to provide clear layering for data abstraction and modularity. Data can be kept at both raw and aggregated levels. Periodically raw data are aggregated and summarized by the data management and/or compaction module. The analytics reporting module can access aggregated data for faster reporting and chart generation. However, raw data are always made available for drill down using the document database module (e.g., MongoDB) to allow regenerating the aggregate data in case of model or algorithm changes.

In the exemplary step #10 for monitoring system health, the system health monitor module monitors the overall health of various components. For example, these can include availability, response times, resource usage (e.g., CPU, memory, disk, network bandwidth, etc.). Alarms are raised when specific thresholds are crossed.

In the data acquisition phase, e.g., step #1 of FIG. 7, the web server(s) running behind the load balancer module receive the user POST request. This POST request is self-contained and it originated from the analytics engine code (e.g., JavaScript) installed on the commercial entity's website. For example, the POST contains information about user activity on a particular webpage (e.g., page URL, action type, clicked on a photo or a link, submitted a form, etc.).

The data received is saved into a database so that analytics engine can analyze the data (e.g., using the real-time analytics module) in real time, so in just a short while later (e.g., fractions of a second to seconds depending on the specific customer or use case trigger requirements), the insight information is generated and ready to be presented in an exemplary analytics report. In some implementations for saving the incoming data, the process is broken down into two exemplary steps. A first step is to extract the data from the POST request and save it locally. The second step is to insert this data into the database (e.g., local or remote). These two work items are performed by two separated processes, executing independent of each other. This decoupling can allow for: (i) independent scaling on web servers and database insertion processes, (ii) independent restart of web services and archiving processes in case the need arises, (ii) ability for additional intelligent processing before data is archived—more complex logic can be applied outside of web server context (e.g., compaction of data), and/or (iv) and/or the ability to trigger data analytics engine execution at different stages of the process.

An exemplary workflow of the real-time analytics module or modules can include the following. For example, a POST request is received by web server. The web server invokes handler and passes data to it. A handler extracts data from the request and saves it in a file locally on the web server. A second (different) process detects the file saved by the web server and loads it. The useful data is extracted from the POST request and is it is then inserted into the schema less database.

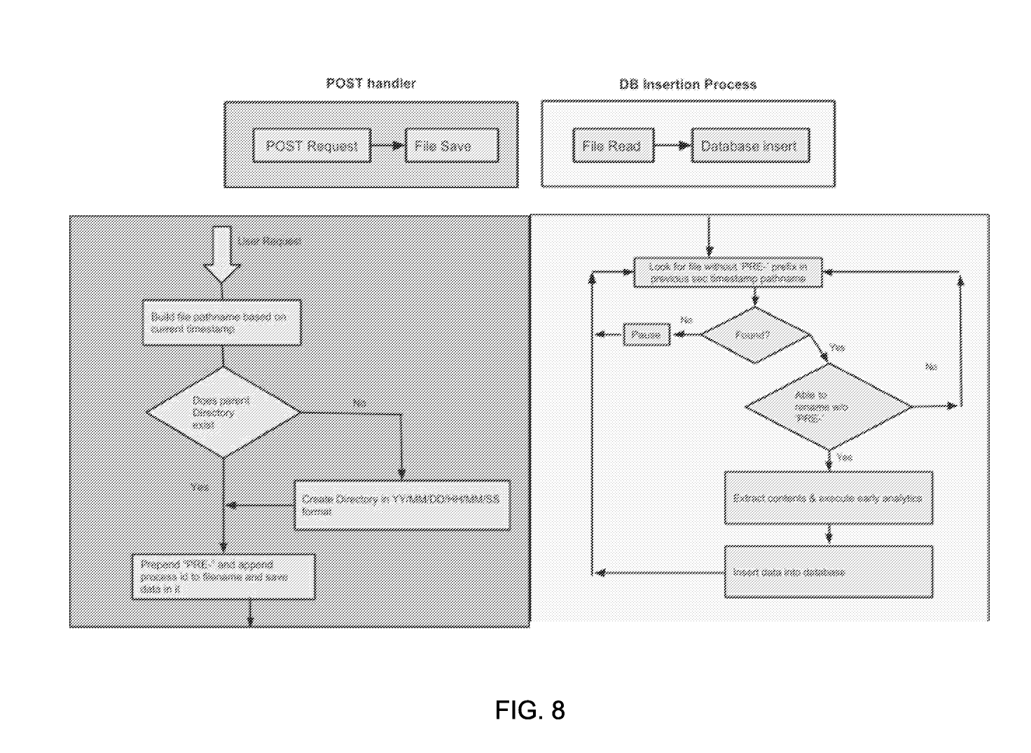

FIG. 8 shows two exemplary processes for data management of the exemplary analytics engine to manage POSTs and insert data into a database. A first process shown as the POST handler process in the left panel of FIG. 8 saves the file in a tree structure, e.g., by time of request creation, so as to improve efficiency and speed of IO operations. For example, this exemplary type of file structure has significant advantages and allows for very high incoming request handling: For example, directories can be named in the following format: Year/Month/Day/Hour/Minute/Second. Some examples include:

### 2014/04-Apr/20-Sunday/21/53/08,

### 2014/04-Apr/21-Monday/10/20/05, . . .

2014/07-Jul/04-Friday/09/45/00. For example, granularity can be terminated at “Second” or “Minute” (in example above), depending on the rate of incoming traffic. For example, no single directory may have too many files for processing, significantly faster file IO performance. For example, multiple processes can be spawned to process these files if a single process can't keep up with the incoming user request rate. For example, directories can be created only if a file is being placed in it. In addition, for example, the files can be processed so quickly that most of the operations happen in memory rather than as actual IO on the disk.

A second process shown as the DB Insertion process in the right panel of FIG. 8 starts with the current timestamp and look for files in that pathname with prefix ‘PRE-’ and follows these exemplary steps. This process attempts to rename the file by remove the ‘PRE-’ prefix. For example, this guarantees that there is no conflict with another process trying to insert this exact file contents into the database. If successful, that means this is the only process operating on this file, e.g., in which it extract contents of the user POST from file, and processes and inserts data into database. If unsuccessful, then the process continues to look for file with ‘PRE-’ prefix in the directory and repeat such steps. If no file found, for example then the process can pause 250 millisecond, advance time but not beyond current time, and/or repeat the first step.

The split design of the exemplary processes in FIG. 8 has an additional advantage that the database servers don't need to be redundant. The files containing the user POST data act as the backup copy of the data and can be used to rebuild the database, should the need arise. In addition, for example, since most of the data in the files is text, they can be reasonably well compressed and archived reducing space requirements.

Exemplary Implementations

In implementations, the disclosed systems and methods can be used to enhance the conversion of E-commerce leads into sales for a commercial entity. For example, the exemplary real-time web and voice analytics techniques can analyze web behavior of an end user (e.g., potential customer of a commercial entity with a web presence) and use it to support the real-time sales transaction, e.g., whether it is using an agent or self-help on the web. In an example scenario, an end user is surfing the web and spends time on an E-commerce company's web site over multiple days. No login and password information is given/inputted to the website. After such time searching individually, the end-user contacts the E-Commerce company for discussions, e.g., to inquire more about a product or service of interest. For example, the contact could be via a phone call or instant message IM chat session, or via video conference. For example, the discussion could be with a live agent or self-service. All throughout the initial content surfing and interaction, the disclosed technique can track the end user's website traversal on that E-commerce site and the salient points, which can be used to help the agent in understanding the end user's needs or interests (e.g., getting on same page as the end-user). For example, such information is pushed to the live agent so that the agent can better help the end user and/or offer products uniquely focused on end-user interest. In the exemplary case of self-fulfillment at the website (e.g., no live agent support), the information collected by the disclosed technique can be used to configure the website in a way that is unique to the interests and focus on the end-user (e.g., presenting or “painting” the type and/or organization of content on the website tailored to the end user), thereby making the session more productive.

In some exemplary implementations, the disclosed techniques can be used to track contact center discussions and “teleprompt” agent. For example, the exemplary web and voice analytics techniques can record the conversation between an end user and a live agent, transcribe it in real time (on-going) and run real-time analytics to determine unique points that are pushed to the agent in real time (while the interaction is on-going) to help in enhancing the on-going discussion by the agent. In an example scenario, an end user is looking for patio heaters and visits a big box store's website to review information on the available patio heaters. After reading some information, the end user calls up a customer service agent of the big box store, and once connected to the agent, starts a discussion about patio heaters and what size and other parameters he/she needs, etc. Throughout this scenario, the disclosed technique tracks the web traversal and sends that information to the big box store customer service agent prior to and/or during when the communication is initiated and happens. For example, the information can include the types of patio heaters the user reviewed including particular brands, technical specifications, price ranges, sizes, etc., the amount of time the end user spent on each type and sub-type, and whether the user performed searches of related products or other information. For example, at the beginning of the discussion between the end user and the agent, the agent already would have analyzed and formatted information based on the collected information that informs the agent on what the end user will most likely wish to talk about on patio heaters, including detailed information on patio heaters, e.g., related to technical issues, sales, customer reviews, etc. In addition, the disclosed technique can provide additional relevant and related information about patio heaters made available to agent. This can enable the agent to have rapid information that may anticipate an inquiry by the end user. For example, during the conversation, the end-user starts may wish to discuss the BTU units used in the patio heaters he/she reviewed on the company's website. In this example, voice analytics techniques of the disclosed technology can transcribe that information and determine that more information about BTU units is needed, such that the disclosed technique extracts that information and pushes it to agent in real time, e.g., before or by the time the end user is done talking about the inquiry of BTU units. Thus, by implementing the disclosed technique, the agent has become more informed about BTU and shares relevant information with end user to satisfy the end user's inquiry, which may make the end user more ready to make a purchase.

In some exemplary implementations, the disclosed techniques can be used to track device usage and help bolster the support. For example, the exemplary data analytics techniques can use real-time analytics of an end user's device usage to support customer support sessions. In an example scenario, a multi-user, live streaming, gaming console is being used by a some gainers in a game. They play for 2-3 hours and have multiple players playing together and including multiple Internet-based gaming and voice chat sessions operated concurrently via the gaming console devices. The disclosed techniques can include tracking information including what applications are being used, how many players, etc. and send that information to a server operated by the company who produces/manages the game console and/or its applications (e.g., games), where the computer implemented technique of the disclosed technology is also resident. For example, the disclosed technique can track such information and, e.g., for each gaming device, keep an on-going list of usage. In this scenario, for example, the gaming device used by the gainers breaks, is overloaded, etc., or the application being used undergoes a network disruption. The disclosed technique can include prompting the gamer(s) to call the customer service line of the game console producer/manager to and provide an access code which identified that session. When the gamer(s) call the customer service of the game console producer/manager and share information about the damaged session, the disclosed technology can provide real-time analytics that extracts the right session and performs basic game analysis and provides the support agent with what the gamers were doing right before the device(s) stopped working. In this case, for example, the agent may save a substantial amount of time (e.g., 30 minutes or more) that would have otherwise been spent as querying time and also as time to determine what exactly the gamers were doing before device and/or application network malfunctioned. Thus, the disclosed technology can enhance a return to the normal operation and increase customer satisfaction.

In some aspects, techniques are disclosed to provide in real time a specific and actionable list of items to a sales agent (e.g., including a live agent or virtual agent) and/or provide a self-fulfillment part of the web site to reduce discovery time of end user interaction. For example, this interaction can occur after the end user spends a single or multiple sessions on the vendor's website, in which that interaction can be analyzed and utilized to provide the actionable list of items. In an example scenario, an end user is on a cruise ship website considering a cruise vacation. The exemplary collection engine on the cruise ship company's website can collect information the user inquires, e.g., including cruise destination, port departure and port return locations, duration of potential cruises, cabin type, price ranges, and on- and off-boat excursion activities, etc. For example, in many higher price purchases including vacation packages, potential customers prefer speaking with a customer service/sales agent rather than making the purchase purely online. In such instances, based on the analyzed data used to form the exemplary user profile and insight information provided by the disclosed analytics engine, a call center agent could be provided with summarized data and suggested vacation packages (including special price deals) tailored to the end user's interests at the beginning of the interaction without having to ask the user several questions to acquire the information. For example, implementation of the exemplary web and voice analytics technology can save substantial time that often causes potential customers to lose patience and/or second guess the sales transaction. In addition to securing sales for the commercial entity, such exemplary implementations can also enhance the end user's satisfaction with the purchase by being prompted to price savings and services he/she may not have been aware of.

In some aspects, techniques are disclosed to provide in real time a specific and actionable list of items to a sales agent (e.g., including a live agent or virtual agent) and/or provide a self-fulfillment part of the web site to focus on improving conversion of that lead into a sale, e.g., including providing more information about the direct items of interest to the end user, such as background information about the products of interest and related words (e.g., like BTU information for the exemplary person interested in purchasing patio heaters), or additional items or services of interest to the user (e.g., like off-boat excursion packages for the exemplary person interested in the cruise vacation). For example, this interaction can occur after the end user spends a single or multiple sessions on the vendor's website, in which that interaction can be analyzed and utilized to provide the actionable list of items. For example, in the example scenario of the end user considering a cruise vacation, the disclosed technology can be used to provide the agent with ancillary sales opportunities that can be presented to the user during the interaction, e.g., such as on off-boat excursion packages like golf, scuba diving, snorkeling, kayaking, fishing, sight-seeing, etc., that the end user may have already expressed interest in while browsing the website. Additionally, the exemplary analytics engine can provide detailed insight data about such off-boat excursions based on the collected data. For example, if the user mentions he/she is an advanced golfer and a novice or inexperienced diver, the analytics engine can immediately provide a list of more challenging golf course excursions (e.g., versus simpler courses) and scuba diving excursions that include lessons and/or are conducted in safer locations. Also, for example, the actionable list of items can include suggestion information on highly recommended restaurants and activities based on user blogs, tweets, posted likes and dislikes, etc.

In some aspects, techniques are disclosed to provide in real time a specific and actionable list of items to a sales agent (e.g., including a live agent or virtual agent) and/or provide a self-fulfillment part of the web site to focus on improving user experience. For example, this interaction can occur after the end user spends a single or multiple sessions on the vendor's website, in which that interaction can be analyzed and utilized to provide the actionable list of items.

In some aspects, techniques are disclosed to provide in real time a specific and actionable list of items to a sales agent (e.g., including a live agent or virtual agent) and/or provide a self-fulfillment part of the web site to focus on providing technical support (e.g., providing collateral related to that issue). For example, this interaction can occur after the end user spends a single or multiple sessions on the vendor's website, in which that interaction can be analyzed and utilized to provide the actionable list of items. In an example scenario, an end user experiences a disruption of cable TV service. Rather than spend several minutes first navigating the phone directories of the cable TV provider to speak to a technical support agent and then having to explain the details of the problem, the end user can use an online chat service of the cable TV service provider. In such instances where the disclosed analytics technology is implemented by the cable TV service provider, the technical support agent receiving the initial chat message from the end user would already have diagnostic data about the problem, e.g., thereby saving a substantial amount of time that would have otherwise been spent by the user typing to the agent via the chat and answering questions prompted by the agent to determine the reason for the services disruption and means to fix and restore the services.

In some aspects, techniques are disclosed to provide in real time a specific and actionable list of items to a sales agent (e.g., including a live agent or virtual agent) and/or provide a self-fulfillment part of the web site to focus on upsell of related products to the end-user. For example, this interaction can occur after the end user spends a single or multiple sessions on the vendor's website, in which that interaction can be analyzed and utilized to provide the actionable list of items.

For example, the web, voice, and/or social media activity includes mobile-based communications activity, e.g., in which in some examples, the communication medium includes chat, email, voice, video. For example, the interaction can include the use of transcription in real time of a communication session between the end user and the commercial entity or other entities occupying the communication medium. For example, the disclosed techniques can also be implemented to predict consumer behavior of the end user and apply the predicted consumer behavior information for reducing of discovery time of end user interaction, converting the lead into a sale, improving of the user experience, providing the technical support, and/or upselling of related products to the end user.

### Examples

The following examples are illustrative of several embodiments of the present technology. Other exemplary embodiments of the present technology may be presented prior to the following listed examples, or after the following listed examples.

In one example of the present technology (example 1), a computer implemented method for providing real-time data analytics to a commercial entity includes collecting data associated with an end user in real-time during an interaction of the end user with the commercial entity via one or more of a website communication, a voice communication, and a social media network communication; analyzing the collected data in real-time to extract end user specific content; and creating a data index of the analyzed data in one or more data insight models.

Example 2 includes the computer implemented method as in example 1, further including reporting results from the data insight models to provide information based on the end user specific content for presentation to at least one of an agent of the commercial entity or the end user in real time.

Example 3 includes the computer implemented method as in example 2, in which the information to the agent includes an actionable list of items to ask or suggest to the end user.

Example 4 includes the computer implemented method as in example 1, in which the collected data includes at least one of keywords, search criteria, user physical location, viewed websites, customer relationship management (CRM) data, billing data, information posts, user posted and viewed tweets, user posted likes and dislikes, or information uploads and downloads of content of interest to the end user.

Example 5 includes the computer implemented method as in example 1, in which the analyzing includes performing one or more of data mining, keyword searching or recognizing, data categorizing, and data relevancy identifying techniques on the collected data.

Example 6 includes the computer implemented method as in example 1, further including collecting outside user data about the end user from another entity; and analyzing the outside user data to extract the end user specific content.

Example 7 includes the computer implemented method as in example 1, in which the created data index includes a profile of the end user based on the extracted end user specific content.

In one example of the present technology (example 8), a computer implemented method for providing real-time analytics to a commercial entity based on performance by a user device operated by an end user includes collecting data from the user device in real-time during a network interaction with the commercial entity via one or more of a website communication, voice communication, or social media communication; analyzing the collected data in real-time to extract end user specific data about the user device and the network interaction: and reporting the analyzed end user specific data to provide information to one or both of an agent of the commercial entity or the end user in the real time.

Example 9 includes the computer implemented method as in example 8, in which the information provided to the agent includes diagnostic information about a malfunction of the user device.

Example 10 includes the computer implemented method as in example 8, in which the information provided to the agent includes an actionable list of items to ask or suggest to the end user.

Example 11 includes the computer implemented method as in example 8, further including collecting user data associated with the end user from one or both of the commercial entity or another entity, in which the collected data includes at least one of keywords, search criteria, user physical location, viewed websites, customer relationship management (CRM) data, billing data, information posts, user posted and viewed tweets, user posted likes and dislikes, or information uploads and downloads of content of interest to the end user.

Example 12 includes the computer implemented method as in example 11, further including analyzing the collected user data to extract the end user specific content, in which the analyzing includes performing one or more of data mining, keyword searching or recognizing, data categorizing, and data relevancy identifying techniques on the collected user data.

In one example of the present technology (example 13), a system for providing data analytics includes one or more computers of an analytics entity in communication with one or more computers of a commercial entity and/or computing devices of end users, in which the one or more computers of the analytics entity are configured to include data collection module configured to collect data associated with an end user in real-time from one or both of the one or more computers of the commercial entity or a computing device of the end user; and an analytics module to analyze the collected data to provide insight information about the end user to the commercial entity in real time.

Example 14 includes the system as in example 13, in which the analytics module includes a data processing pipeline module to process the collected data to identify end user specific content, and a reporting module to extract the end user specific content and generate a report including an actionable list of items based on the end user specific content for presentation to at least one of an agent of the commercial entity or the end user.

Example 15 includes the system as in example 13, in which the data collection module is configured to collect the data associated with an end user in real-time during an interaction of the end user with the commercial entity via one or more of a website communication, a voice communication, and a social media network communication.

Example 16 includes the system as in example 13, in which the collected data includes at least one of keywords, search criteria, user physical location, viewed websites, customer relationship management (CRM) data, billing data, information posts, user posted and viewed tweets, user posted likes and dislikes, or information uploads and downloads of content of interest to the end user.

Example 17 includes the system as in example 13, in which in the one or more computers of the analytics entity are configured to include a data management module to upload the collected data to a data storage unit on one or both of the one or more computers of the analytics entity or the one or more computers of the commercial entity.

Example 18 includes the system as in example 13, in which the analytics module is configured to generate a report including the insight information for presentation in real time to an agent of the commercial entity operating a computer of the one or more computers of the commercial entity.

Example 19 includes the system as in example 18, in which the report presented to the agent in real time includes an actionable list of items to ask or suggest to the end user.

Example 20 includes the system as in example 18, in which the report is presented to the agent in real time by at least one of a screen splash interface, executive reporting dashboard, or an updated website on the computer of the agent.

In one example of the present technology (example 21), a system for providing real-time analytics includes a data communications unit of a commercial entity capable of communicating data with one or more communication devices of an end user via one or more of website communication, voice communication, or social media communication to collect data from the end user; a data storage unit in communication with the data communications unit to store the collected data; and a data analytics unit configured to analyze the collected data to provide insight information about the end user to the commercial entity in real time, the data analytics unit comprising a data processing pipeline module to process the collected data to identify end user specific content and a reporting module to extract the end user specific content and generate a report including an actionable list of items based on the end user specific content for presentation to at least one of an agent of the commercial entity or the end user.

Example 22 includes the system as in example 21, in which the data communications unit includes a data provisioning module to customize data communicated via the website communication based on a requirement parameter of the website.

Example 23 includes the system as in example 21, in which the data analytics unit further comprises an interface module to provide a user interface to the agent to represent the report.

In an additional example of the present technology (example 1A), a system for providing data analytics includes a communication network including computers or servers, one or more computers or servers of an analytics entity in the communication network being in communication with one or more computers or servers of a commercial entity and/or computing devices of end users via the communication network, in which the one or more computers or servers of the analytics entity are configured to include: data collection module configured to collect data associated with an end user in real-time from one or both of the one or more computers or servers of the commercial entity or a computing device of the end user; and an analytics module to analyze the collected data to provide insight information about the end user to the commercial entity in real time.

Example 2A includes the system as in example 1A, in which the analytics module includes a data processing pipeline module to process the collected data to identify end user specific content and a reporting module to extract the end user specific content and generate a report including an actionable list of items based on the end user specific content for presentation to at least one of an agent of the commercial entity or the end user.

Example 3A includes the system as in example 1A, in which the data collection module is configured to collect the data associated with an end user in real-time during an interaction of the end user with the commercial entity via one or more of a website communication, a voice communication, and a social media network communication.

Example 4A includes the system as in example 1A, in which in the one or more computers or servers of the analytics engine are configured to include a data management module to upload the collected data to a data storage unit on one or both of the one or more computers or servers of the analytics entity or the one or more computers or servers of the commercial entity.

Example 5A includes the system as in example 1A, in which the analytics module is configured to generate a report including the insight information for presentation in real time to an agent of the commercial entity operating a computer of the one or more computers or servers of the commercial entity.

Example 6A includes the system as in example 5A, in which the report presented to the agent in real time includes an actionable list of items to ask or suggest to the end user.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question. e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data. e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A computer implemented method for providing real-time data analytics to a commercial entity, including:
collecting data associated with an end user in real-time during an interaction of the end user with the commercial entity via one or more of a website communication, a voice communication, and a social media network communication;
analyzing the collected data in real-time to extract end user specific content; and
creating a data index of the analyzed data in one or more data insight models.

2. The computer implemented method as in claim 1, further comprising:
reporting results from the data insight models to provide information based on the end user specific content for presentation to at least one of an agent of the commercial entity or the end user in real time.

3. The computer implemented method as in claim 2, wherein the information to the agent includes an actionable list of items to ask or suggest to the end user.

4. The computer implemented method as in claim 1, wherein the collected data includes at least one of keywords, search criteria, user physical location, viewed websites, customer relationship management (CRM) data, billing data, information posts, user posted and viewed tweets, user posted likes and dislikes, or information uploads and downloads of content of interest to the end user.

5. The computer implemented method as in claim 1, wherein the analyzing includes performing one or more of data mining, keyword searching or recognizing, data categorizing, and data relevancy identifying techniques on the collected data.

6. The computer implemented method as in claim 1, further comprising:
collecting outside user data about the end user from another entity; and
analyzing the outside user data to extract the end user specific content.

7. The computer implemented method as in claim 1, wherein the created data index includes a profile of the end user based on the extracted end user specific content.

8. A computer implemented method for providing real-time analytics to a commercial entity based on performance by a user device operated by an end user, the computer implemented method including:
collecting data from the user device in real-time during a network interaction with the commercial entity via one or more of a website communication, voice communication, or social media communication;
analyzing the collected data in real-time to extract end user specific data about the user device and the network interaction; and
reporting the analyzed end user specific data to provide information to one or both of an agent of the commercial entity or the end user in the real time.

9. The computer implemented method as in claim 8, wherein the information provided to the agent includes diagnostic information about a malfunction of the user device.

10. The computer implemented method as in claim 8, wherein the information provided to the agent includes an actionable list of items to ask or suggest to the end user.

11. The computer implemented method as in claim 8, further comprising:
collecting user data associated with the end user from one or both of the commercial entity or another entity,
wherein the collected data includes at least one of keywords, search criteria, user physical location, viewed websites, customer relationship management (CRM) data, billing data, information posts, user posted and viewed tweets, user posted likes and dislikes, or information uploads and downloads of content of interest to the end user.

12. The computer implemented method as in claim 11, further comprising:
analyzing the collected user data to extract the end user specific content,
wherein the analyzing includes performing one or more of data mining, keyword searching or recognizing, data categorizing, and data relevancy identifying techniques on the collected user data.

13. A system for providing data analytics, comprising:
one or more computers of an analytics entity in communication with one or more computers of a commercial entity and computing devices of end users, wherein the one or more computers of the analytics entity are configured to include:
data collection module configured to collect data associated with an end user in real-time from one or both of the one or more computers of the commercial entity or a computing device of the end user; and
an analytics module to analyze the collected data to provide insight information about the end user to the commercial entity in real time.

14. The system as in claim 13, wherein the analytics module includes a data processing pipeline module to process the collected data to identify end user specific content, and a reporting module to extract the end user specific content and generate a report including an actionable list of items based on the end user specific content for presentation to at least one of an agent of the commercial entity or the end user.

15. The system as in claim 13, wherein the data collection module is configured to collect the data associated with an end user in real-time during an interaction of the end user with the commercial entity via one or more of a website communication, a voice communication, and a social media network communication.

16. The system as in claim 13, wherein the collected data includes at least one of keywords, search criteria, user physical location, viewed websites, customer relationship management (CRM) data, billing data, information posts, user posted and viewed tweets, user posted likes and dislikes, or information uploads and downloads of content of interest to the end user.

17. The system as in claim 13, wherein in the one or more computers of the analytics entity are configured to include:
a data management module to upload the collected data to a data storage unit on one or both of the one or more computers of the analytics entity or the one or more computers of the commercial entity.

18. The system as in claim 13, wherein the analytics module is configured to generate a report including the insight information for presentation in real time to an agent of the commercial entity operating a computer of the one or more computers of the commercial entity.

19. The system as in claim 18, wherein the report presented to the agent in real time includes an actionable list of items to ask or suggest to the end user.

20. The system as in claim 18, wherein the report is presented to the agent in real time by at least one of a screen splash interface, executive reporting dashboard, or an updated website on the computer of the agent.

21. A system for providing real-time analytics, comprising:
a data communications unit of a commercial entity capable of communicating data with one or more communication devices of an end user via one or more of website communication, voice communication, or social media communication to collect data from the end user;
a data storage unit in communication with the data communications unit to store the collected data; and
a data analytics unit configured to analyze the collected data to provide insight information about the end user to the commercial entity in real time, the data analytics unit comprising a data processing pipeline module to process the collected data to identify end user specific content and a reporting module to extract the end user specific content and generate a report including an actionable list of items based on the end user specific content for presentation to at least one of an agent of the commercial entity or the end user.

22. The system as in claim 21, wherein the data communications unit includes a data provisioning module to customize data communicated via the website communication based on a requirement parameter of the website.

23. The system as in claim 21, wherein the data analytics unit further comprises an interface module to provide a user interface to the agent to represent the report.
